(19) United States
(12) Patent Application Publication
(10) Pub. No.: US 2026/0116404 A1
(43) Pub. Date: Apr. 30, 2026

(54) PROCESS FOR CHARACTERIZING NEURAL NETWORKS BY PREDOMINANT INPUTS FOR IMPROVED VEHICLE FUNCTIONAL SAFETY

(71) Applicant: FCA US LLC, Auburn Hills, MI (US)

(72) Inventor: Andrew D. Johnson, Auburn Hills, MI (US)

(21) Appl. No.: 18/925,737

(22) Filed: Oct. 24, 2024

(51) Int. Cl. B60W 50/04; B60L 3/00; G06N 3/04

(52) U.S. Cl. CPC B60W 50/045; B60L 3/0023; G06N 3/04

(57) ABSTRACT

A functional safety calibration method for a vehicle includes accessing dynamometer data for the vehicle and determining, using the dynamometer data, first output data and N input parameters for a neural network utilized by a primary process of the vehicle to model a vehicle parameter based on the N input parameters, wherein N is an integer greater than one, identifying, based on the first output data, M of the N input parameters that predominantly affect the modeling of the vehicle parameter by the neural network, wherein M is an integer that is less than N, determining a function of at least M identified input parameters based on the first output data, and calibrating a secondary process using the determined function, wherein the secondary process is configured to be utilized by the vehicle as a functional safety check for the primary process.

### FIELD

The present application generally relates to vehicle functional safety and, more particularly, to a process for characterizing neural networks by predominant inputs for improved vehicle functional safety.

### BACKGROUND

Vehicle functional safety refers to the implementation of protection measures to mitigate or eliminate hazards caused by a malfunction of a vehicle-level system. This typically involves comparing an output of a primary process to an output of a separate secondary process (e.g., using the same or a smaller lookup table), which should generate the same values. One example of vehicle functional safety is the verification of an engine torque command. For primary processes involving look-up tables, the look-up tables could be copied or reduced/simplified to calibrate the secondary process. In the case of primary processes involving complex neural networks, however, there is no easy way to calibrate the secondary process as it would require collecting and analyzing a large amount of on-road driving data at different conditions, which increases calibration time/costs. Accordingly, while such conventional vehicle functional safety systems do work well for their intended purpose, there exists an opportunity for improvement in the relevant art.

### SUMMARY

According to one example aspect of the invention, a functional safety calibration system for a vehicle is presented. In one exemplary implementation, the functional safety calibration system comprises a memory storing dynamometer data for the vehicle and a calibration computing system configured to access the memory to obtain the dynamometer data for the vehicle, determine, using the dynamometer data, first output data and N input parameters for a neural network utilized by a primary process of the vehicle to model a vehicle parameter based on the N input parameters, wherein N is an integer greater than one, identify, based on the first output data, M of the N input parameters that predominantly affect the modeling of the vehicle parameter by the neural network, wherein M is an integer that is less than N, determine a function of at least M identified input parameters based on the first output data, and calibrate a secondary process using the determined function, wherein the secondary process is configured to be utilized by the vehicle as a functional safety check for the primary process.

In some implementations, N is greater than two and M equals two. In some implementations, the calibration computing system is further configured to determine the function by determining secondary inputs as a function of the two identified inputs as outputs, generating second output data by executing the neural network using the two identified inputs and the secondary inputs as input, and determining the function that generates the second output data based on the secondary inputs that generates the second output data. In some implementations, the calibration computing system is further configured to fine-tune the function based on a value of the function at different breakpoints and selective adjustments to weights or biases of the neural network.

In some implementations, the calibrating of the secondary process using the determined function includes generating a look-up table to be utilized by the secondary process. In some implementations, the generated look-up table is uploaded to a control unit of the vehicle that is configured to execute the secondary process. In some implementations, the control unit of the vehicle is a separate core of a same processor that is configured to execute the primary process, a separate processor of a same electronic control unit (ECU) that is configured to execute the primary process, or a separate ECU than the ECU that is configured to execute the primary process. In some implementations, the neural network is an artificial neural network (ANN). In some implementations, the vehicle parameter is engine torque and wherein the secondary process is a functional safety check for an engine torque determined by the primary process. In some implementations, the vehicle parameter is a control parameter for an autonomous driving feature, and wherein the secondary process is a functional safety check for the control parameter determined by the primary process.

According to another example aspect of the invention, a functional safety calibration method for a vehicle is presented. In one exemplary implementation, the functional safety calibration method comprises storing, at a memory, dynamometer data for the vehicle, accessing, by a calibration computing system, the memory to obtain the dynamometer data for the vehicle, determining, by the calibration computing system and using the dynamometer data, first output data and N input parameters for a neural network utilized by a primary process of the vehicle to model a vehicle parameter based on the N input parameters, wherein N is an integer greater than one, identifying, by the calibration computing system and based on the first output data, M of the N input parameters that predominantly affect the modeling of the vehicle parameter by the neural network, wherein M is an integer that is less than N, determining, by the calibration computing system, a function of at least M identified input parameters based on the first output data, and calibrating, by the calibration computing system, a secondary process using the determined function, wherein the secondary process is configured to be utilized by the vehicle as a functional safety check for the primary process.

In some implementations, N is greater than two and M equals two. In some implementations, the determining of the function further comprises determining secondary inputs as a function of the two identified inputs as outputs, generating second output data by executing the neural network using the two identified inputs and the secondary inputs as input, and determining the function that generates the second output data based on the secondary inputs that generates the second output data. In some implementations, the functional safety calibration method further comprises fine-tuning, by the calibration computing system, the function based on a value of the function at different breakpoints and selective adjustments to weights or biases of the neural network.

In some implementations, the calibrating of the secondary process using the determined function includes generating a look-up table to be utilized by the secondary process. In some implementations, the generated look-up table is uploaded to a control unit of the vehicle that is configured to execute the secondary process. In some implementations, the control unit of the vehicle is a separate core of a same processor that is configured to execute the primary process, a separate processor of a same ECU that is configured to execute the primary process, or a separate ECU than the ECU that is configured to execute the primary process. In some implementations, the neural network is an ANN. In some implementations, the vehicle parameter is engine torque and wherein the secondary process is a functional safety check for an engine torque determined by the primary process. In some implementations, the vehicle parameter is a control parameter for an autonomous driving feature, and wherein the secondary process is a functional safety check for the control parameter determined by the primary process.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIG. 1 is a functional block diagram of an example functional safety calibration system for a vehicle according to the principles of the present application; and

FIG. 2 is a flow diagram of an example functional safety calibration method for a vehicle according to the principles of the present application.

### DESCRIPTION

As discussed above, vehicle functional safety involves comparing an output of a primary process to an output of a separate secondary process (e.g., using the same or a smaller lookup table), which should generate the same values. For primary processes involving look-up tables, the look-up tables could be copied or reduced/simplified to calibrate the secondary process. In the case of primary processes involving complex neural networks, however, there is no easy way to calibrate the secondary process as it would require collecting and analyzing a large amount of on-road driving data at different conditions, which increases calibration time/costs.

Accordingly, techniques are presented herein that simplify the output of a neural network (e.g., an artificial neural network, or ANN) having N inputs (N>1) to a lookup table with, at the most, M inputs (M≤N−1). In practice, the neural network will typically include a large quantity of inputs (N>2) and the lookup table will typically include two inputs (M=2). This simplification process involves obtaining dynamometer data for the vehicle and associating it with output data and the N inputs to the neural network and identifying which M (e.g., M=2) of the N inputs most predominantly affect the neural network output. Once identified, a function is then derived based on the M identified inputs. This function can be fine-tuned at different breakpoints until a final function (look-up table) is obtained and thereafter used for functional safety verification of the neural network output.

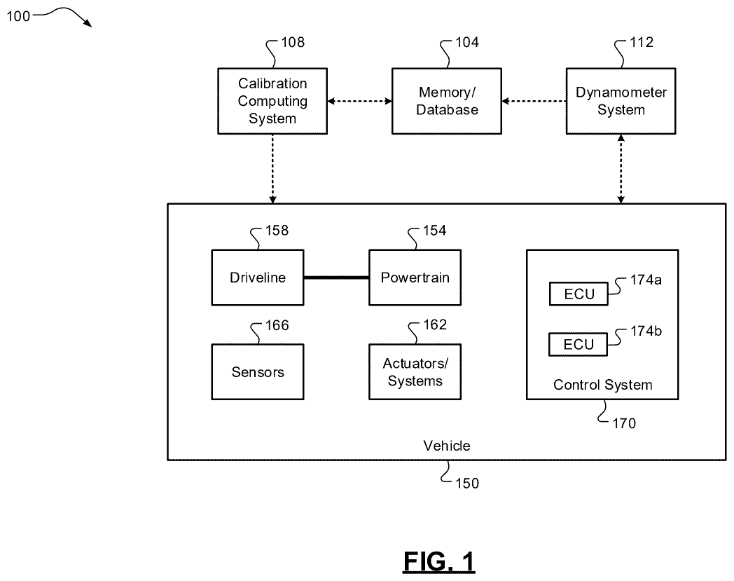

Referring now to FIG. 1, a functional block diagram of an example functional safety calibration system 100 for a vehicle 150 according to the principles of the present application is illustrated. The calibration system 100 generally comprises a database or memory 104 configured to store dynamometer data generated or collected by operating the vehicle 150 on a dynamometer system 112 in a controlled environment (i.e., not on-road data collection). The calibration system 100 also comprises a calibration computing system 108 configured to access the memory 104 and to perform the functional safety calibration techniques of the present application, which are described in greater detail below.

It will be appreciated that while shown as being a separate (e.g., remote) memory system, the memory 104 could be part of or integrated in the calibration computing system 108. The calibration computing system 108 is also configured to, once the functional safety calibration is complete, upload calibration data (e.g., a calibrated look-up table) for a secondary process to the vehicle 150. The vehicle 150 generally comprises a powertrain 154 configured to generate and transfer torque to a driveline 158 for vehicle propulsion.

The vehicle 150 also includes various actuator systems 162, such as engine/motor actuators, brake actuators, and autonomous driving system actuators, and sensors 166. Non-limiting examples of these autonomous driving systems include object detection, collision avoidance (automated emergency braking, evasive maneuvering, etc.), and automated lane keeping/changing. A control unit or system 170 of the vehicle 150 includes a plurality of electronic control units (ECUs), each of which could one or more processor, and each processor could include one or more cores. For functional safety purposes, primary and secondary processes can be executed in by different processors/cores/ECUs of the control system 170. In the illustrated example, the control system 170 includes two ECUs 174a and 174b, with ECU 174a being configured to execute a primary process and ECU 174b being configured to execute a secondary process as part of a functional safety check for the primary process.

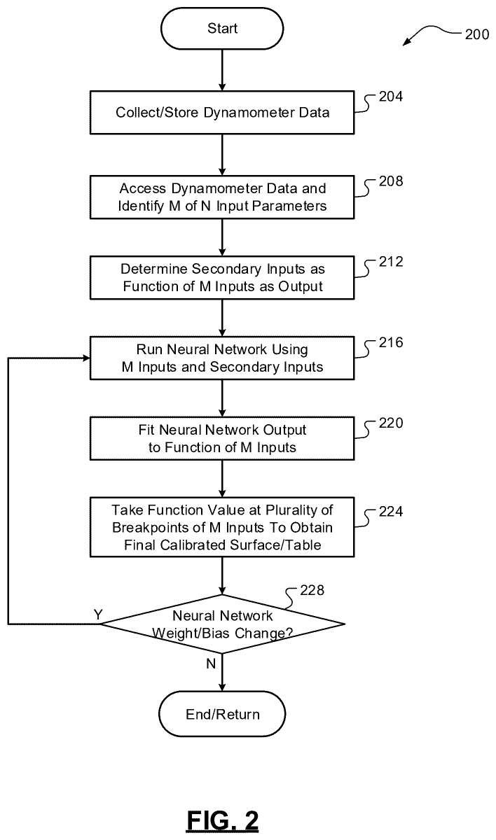

Referring now to FIG. 2 and with continued reference to FIG. 1, a flow diagram of an example functional safety calibration method 200 for a vehicle according to the principles of the present application is illustrated. While the method 200 specifically references the functional safety calibration system 100 and the vehicle 150 of FIG. 1, it will be appreciated that the method 200 could be applicable to any suitably configured vehicle. The method 200 begins at 204 where the dynamometer data is collected over an entire operating range of the vehicle and stored at the memory 204. As mentioned above, the dynamometer data could be collected by operating the vehicle 150 on a dynamometer system in a controlled environment and measuring a plurality of vehicle parameters corresponding to N (N>1) inputs to a neural network (e.g., an artificial neural network, or ANN) configured to model and output a vehicle parameter. In most applications, N is greater than two:

$$Out = {f}_{ANN} ( x , y , z , a , b , c , … ) , \qquad ( 1 )$$

where Out represents the dynamometer data (first output data), f_{ANN} represents the neural network, and x, y, z, a, b, and c represent some of the N inputs.

At 208, the calibration computing system 108 accesses the memory 204 to obtain the dynamometer data and identifies which M (M<N) of the N input parameters predominantly affect the modeling of the vehicle parameter by the neural network f_{ANN} (i.e., the output Out). In one exemplary implementation, N is greater than two and M equals two:

$$( {x}_{main} , {y}_{main} ) = Two Max ( \frac{\partial f}{\partial x} , \frac{\partial f}{\partial y} , \frac{\partial f}{\partial z} , … ) , \qquad ( 2 )$$

where xₘₐᵢₙ and yₘₐᵢₙ are the two identified input parameters. Such a two-input look-up table for the secondary process, for example, would be ideal due to its simplicity and lesser storage requirements. At 212, the calibration computing system 108 determines a range of secondary inputs (z, a, b, etc.) as a function of the two identified inputs (xₘₐᵢₙ, yₘₐᵢₙ) as output:

$$\{ \begin{matrix}{z}_{calc} = {g}_{z} ( {x}_{main} , {y}_{main )} \\ {a}_{calc} = {g}_{a} ( {x}_{main} , {y}_{main )} \\ {b}_{calc} = {g}_{b} ( {x}_{main} , {y}_{main )}\end{matrix} , \qquad ( 3 )$$

where z_{calc}, a_{calc}, and b_{calc} represent the calculated secondary inputs as functions (g_{z}, gₐ, and g_{b}) of the two identified inputs xₘₐᵢₙ and yₘₐᵢₙ.

At 216, the calibration computing system 108 executes or runs the neural network using the two identified inputs (xₘₐᵢₙ, yₘₐᵢₙ) and the calculated secondary inputs (z_{calc}, a_{calc}, b_{calc}) and determines second output data (Out_{calc}):

$${Out}_{calc} = {f}_{ANN} ( {x}_{main} , {y}_{main} , {z}_{calc} , {a}_{calc} , {b}_{calc} , … ) . \qquad ( 4 )$$

At 220, the calibration computing system 108 fits this second output data Out_{calc} to a function of the two identified inputs (xₘₐᵢₙ, yₘₐᵢₙ):

$$h ( x , y ) = {Out}_{calc} , \qquad ( 5 )$$

where h represents the function. At 224, the calibration computing system 108 takes the value of the function h(x,y) at each of a plurality of breakpoints to obtain a final calibration table:

$$Surf = h ( x , y ) \vert ( x = [ 0 , 10 , 20 , \text{…} ] , y = [ 0 , 100 , 2 \; 00 , \text{…} ] ) , \qquad ( 6 )$$

where Surf represents the final calibration surface or table (e.g., two-dimensional table) and [0, 10, 20 . . . ] and [0, 100, 200, . . . ] represent identified or known breakpoints for the function h(x,y).

At 228, the calibration computing system 108 determines whether there has been a subsequent change to the ANN weights or biases since the final calibration surface/table was identified at 224. For example, this change in the neural network weights/biases could occur during vehicle development or during a vehicle update. When false, the method 200 ends. When true, the method 200 returns to 216 for fine-tuning of the calibration for the secondary process. The method 200 does not, however, need to return to 204 and redo the entire calibration process. After the method 200 ends, the final calibration surface/table could be uploaded to the vehicle 150 (e.g., into a memory for a respective core/processor/ECU) and then be used online for functional safety checks of the primary process neural network output. As previously mentioned, two examples of such a usage is engine torque, where the secondary process is a functional safety check for an engine torque determined by the primary process and a control parameter for an autonomous driving feature, where the secondary process is a functional safety check for the control parameter determined by the primary process.

It will be appreciated that the terms “controller” and “control system” as used herein refer to any suitable control device or set of multiple control devices that is/are configured to perform at least a portion of the techniques of the present application. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present application. The one or more processors could be either a single processor or two or more processors operating in a parallel or distributed architecture.

It should also be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

What is claimed is:

1. A functional safety calibration system for a vehicle, the functional safety calibration system comprising:
a memory storing dynamometer data for the vehicle; and
a calibration computing system configured to:
access the memory to obtain the dynamometer data for the vehicle;
determine, using the dynamometer data, first output data and N input parameters for a neural network utilized by a primary process of the vehicle to model a vehicle parameter based on the N input parameters, wherein N is an integer greater than one;
identify, based on the first output data, M of the N input parameters that predominantly affect the modeling of the vehicle parameter by the neural network, wherein M is an integer that is less than N;
determine a function of at least M identified input parameters based on the first output data; and
calibrate a secondary process using the determined function, wherein the secondary process is configured to be utilized by the vehicle as a functional safety check for the primary process.

2. The functional safety calibration system of claim 1, wherein N is greater than two and M equals two.

3. The functional safety calibration system of claim 2, wherein the calibration computing system is further configured to determine the function by:
determining secondary inputs as a function of the two identified inputs as outputs;
generating second output data by executing the neural network using the two identified inputs and the secondary inputs as input; and
determining the function that generates the second output data based on the secondary inputs that generates the second output data.

4. The functional safety calibration system of claim 3, wherein the calibration computing system is further configured to fine-tune the function based on a value of the function at different breakpoints and selective adjustments to weights or biases of the neural network.

5. The functional safety calibration system of claim 1, wherein the calibrating of the secondary process using the determined function includes generating a look-up table to be utilized by the secondary process.

6. The functional safety calibration system of claim 5, wherein the generated look-up table is uploaded to a control unit of the vehicle that is configured to execute the secondary process.

7. The functional safety calibration system of claim 6, wherein the control unit of the vehicle is a separate core of a same processor that is configured to execute the primary process, a separate processor of a same electronic control unit (ECU) that is configured to execute the primary process, or a separate ECU than the ECU that is configured to execute the primary process.

8. The functional safety calibration system of claim 1, wherein the neural network is an artificial neural network (ANN).

9. The functional safety calibration system of claim 8, wherein the vehicle parameter is engine torque and wherein the secondary process is a functional safety check for an engine torque determined by the primary process.

10. The functional safety calibration system of claim 8, wherein the vehicle parameter is a control parameter for an autonomous driving feature, and wherein the secondary process is a functional safety check for the control parameter determined by the primary process.

11. A functional safety calibration method for a vehicle, the functional safety calibration method comprising:
storing, at a memory, dynamometer data for the vehicle;
accessing, by a calibration computing system, the memory to obtain the dynamometer data for the vehicle;
determining, by the calibration computing system and using the dynamometer data, first output data and N input parameters for a neural network utilized by a primary process of the vehicle to model a vehicle parameter based on the N input parameters, wherein N is an integer greater than one;
identifying, by the calibration computing system and based on the first output data, M of the N input parameters that predominantly affect the modeling of the vehicle parameter by the neural network, wherein M is an integer that is less than N;
determining, by the calibration computing system, a function of at least M identified input parameters based on the first output data; and
calibrating, by the calibration computing system, a secondary process using the determined function, wherein the secondary process is configured to be utilized by the vehicle as a functional safety check for the primary process.

12. The functional safety calibration method of claim 11, wherein N is greater than two and M equals two.

13. The functional safety calibration method of claim 12, wherein the determining of the function further comprises:
determining secondary inputs as a function of the two identified inputs as outputs;
generating second output data by executing the neural network using the two identified inputs and the secondary inputs as input; and
determining the function that generates the second output data based on the secondary inputs that generates the second output data.

14. The functional safety calibration method of claim 13, further comprising fine-tuning, by the calibration computing system, the function based on a value of the function at different breakpoints and selective adjustments to weights or biases of the neural network.

15. The functional safety calibration method of claim 11, wherein the calibrating of the secondary process using the determined function includes generating a look-up table to be utilized by the secondary process.

16. The functional safety calibration method of claim 15, wherein the generated look-up table is uploaded to a control unit of the vehicle that is configured to execute the secondary process.

17. The functional safety calibration method of claim 16, wherein the control unit of the vehicle is a separate core of a same processor that is configured to execute the primary process, a separate processor of a same electronic control unit (ECU) that is configured to execute the primary process, or a separate ECU than the ECU that is configured to execute the primary process.

18. The functional safety calibration method of claim 11, wherein the neural network is an artificial neural network (ANN).

19. The functional safety calibration method of claim 18, wherein the vehicle parameter is engine torque and wherein the secondary process is a functional safety check for an engine torque determined by the primary process.

20. The functional safety calibration method of claim 18, wherein the vehicle parameter is a control parameter for an autonomous driving feature, and wherein the secondary process is a functional safety check for the control parameter determined by the primary process.
